(19) United States
(12) Patent Application Publication
(10) Pub. No.: US 2009/0162207 A1
(43) Pub. Date: Jun. 25, 2009

(54) Method For The Manufacture Of An Erosion Protection Layer And A Component With Said Erosion Protection Layer

(75) Inventors: Thomas Peters, Winterthur (CH); Eduard Denzler, Elgg (CH); Peter Ernst, Stadel (CH); Martin Danner, Winterthur (CH); Fouad Cheaitany, Winterthur (CH)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Sulzer Markets And Technology AG, Winterthur (CH)

(21) Appl. No.: 12/271,111

(22) Filed: Nov. 14, 2008

(30) Foreign Application Priority Data
Dec. 21, 2007 (EP) 07123914.9

(51) Int. Cl. B64C 27/46; B23K 26/00

(52) U.S. Cl. 416/224; 219/121.64

(57) ABSTRACT

In accordance with the invention a method for the manufacture of an erosion protection layer on a metallic substrate is proposed in which a material is welded onto the metallic substrate (2, 2′). The material is a steel which contains at least 0.1% carbon and at least 12% chrome. The material is applied to the substrate (2, 2′) by laser deposition welding. A component (1, 1′) is further proposed by the invention with a metallic substrate (2, 2′) and an erosion protection layer (3, 3′) applied on the substrate (2, 2′), wherein the erosion protection layer (3, 3′) is manufactured using a method in accordance with the invention.

The invention relates to a method for the manufacture of an erosion protection layer on a substrate and to a component with such an erosion protection layer in accordance with the pre-characterizing part of the independent claim in the respective category.

Damage to components caused by erosion presents a great problem in many technical and industrial fields. Thus, for example considerable damage can occur on the turbine blades in steam turbines due to water droplet erosion. In particular in the low temperature range of the turbine or also in low pressure steam turbines it can happen that water droplets separate out of the steam which then impact against the rotating turbine blades of the rotors or the stationary turbine blades of the guide vanes and lead to erosion there and thus to material abrasion.

In the rotating turbine blades it is the blade leading edges which are particularly exposed to water droplet erosion.

It is known to harden the regions most liable to erosion after manufacture by means of an intentional introduction of heat, for example the blade leading edge, for the protection against the effects of erosion such as these. This can, for example, take place by induction hardening or laser hardening. The results achieved by this are not satisfactory however.

It is further known to protect the blade front edge by the brazing on of a shield or by means of the laser deposition welding of a hard layer. Nowadays it is usual to use stellites, both for the solution with the shield and also for the laser deposition welding. Stellites, such as stellite 6 for example, are well-known cobalt chrome alloys, which are often used to protect components against wear, abrasion or corrosion.

The disadvantage of stellites is that they are difficult to machine. Welding processes with stellites are usually expensive and can only be mastered with difficulty. Residual stresses and the formation of cracks is the result. The soldering on of stellite shields is a problematic procedure which is difficult to master. Usually, when welding or soldering stellites, additional heat treatments have to be carried out subsequently. In spite of such, in part complicated finishing treatments the resistance to erosion attained and also the bonding of the stellites on the substrate, are not always satisfactory.

Stellites are further less suitable or even unsuitable for the repair of already damaged blade front edges, when for example parts of the blade front edge have to be built up anew because the stellites as material for hard coatings are actually not construction materials.

The problem of water droplet erosion can, however, also arise in gas turbines. Here water droplet erosion can occur, in particular on the compressor side of the turbine where air is sucked in and subsequently compressed. The condensing out of water droplets from the air which has been sucked in can result, which then impact onto the blades of the compressor stage of the turbine.

Erosion in general can also lead to considerable problems in other flow machines or rotary machines. Signs of erosion often occur on the wheels of water turbines, for example Pelton turbines, when a high proportion of alluvial particles such as sand or other solids are contained in the water. Erosion as a result of sand or another solid can also lead to considerable damage to compressor blades and to turbine blades.

Furthermore, the term erosion is used to cover all damage which can arise through cavitation at the blades of water turbines or rotary pumps. The need to guarantee a better protection of the components against the effects of erosion also exists here.

Starting from this prior art it is the object of the invention to propose a method with which components, particularly components from flow engines or rotary engines can be effectively protected against erosion. The method should be suitable both for the manufacture of new articles and for the repair of a component. It is further the object of the invention to propose a component which is resistant to erosion.

The subjects of the invention satisfying this object are characterized by the independent claims in the respective category.

Therefore, in accordance with the invention, a method is proposed for the generation of an erosion protection layer on a metallic substrate in which a material is welded onto the metallic layer. The material is a steel, which contains at least 0.1% carbon and at least 12% chrome. The material is applied to the substrate by laser deposition welding.

Surprisingly, it has been shown that a very good erosion protection layer can be generated by laser deposition welding of a steel of low carbon content on a substrate in a simple manner which adheres very well, has a high degree of hardness and a very good resistance to corrosion.

Moreover, steels of this kind are reasonably priced, so that the method in accordance with the invention can be carried out considerably more economically than other methods for the protection against erosion.

However, these steels can either not be welded conventionally or only with difficulty with a lot of complications such as pre-heating and subsequent heat treatments.

It is further advantageous that steel, which is suitable for the method of the invention, can be processed in a simple manner and in a reliable process by means of laser deposition welding.

In addition, as a result of the use of laser deposition welding, only a narrow heat introduction zone develops on the substrate, so that the basic material of the substrate and its heat treatment state is only influenced slightly, if at all. Subsequent heat treatments can be dispensed with for this reason, which makes the method in accordance with the invention simpler, faster and more economical.

It is particularly advantageous in terms of the resistance to erosion when the material contains at least 0.2% carbon and preferably at least 0.4% carbon. Steels of this kind containing a high percentage of carbon can still be processed by means of laser deposition welding without problems.

A preferred embodiment is when the repair of a component is carried out using the method in accordance with the invention. The materials used for the method in accordance with the invention are also in particular suitable as a construction material, in contrast to other materials used for erosion protection, so that the reconstruction of damaged surfaces is possible in a simple manner using the method in accordance with the invention.

Another preferred embodiment is to carry out the manufacture of a new component using the method in accordance with the invention. By means of the manufacture of an erosion protection layer in accordance with the invention on a metallic substrate, new parts can be manufactured simply which have an excellent resistance to erosion.

In accordance with a preferred application the component is a compressor or turbine blade. In this arrangement it can also be the turbine blade of a steam turbine. Erosion damage caused by water droplets often occurs in these. The method in accordance with the invention is suitable both for the repair of damaged turbine blades and for the protection against erosion in the manufacture of new turbine blades. They can also be blades of a gas turbine where erosion damage as a result of water droplets or solid material particles can occur at the compressor side or impeller side in particular. The turbine blades can further also be blades of the propeller of a liquid turbine, in particular of a water turbine, for example of a Pelton rotor, where erosion damage can occur through alluvial particles such as sand or through the effects of water. Erosion damage can in particular also be a result of damage caused by cavitation.

An advantageous measure is that only the region of the substrate which is most liable to erosion in the operating state is provided with an erosion protection layer. In this way material, time and money can be saved. In a turbine blade of a gas turbine or of a steam turbine this region is the blade leading edge of a turbine blade, for example.

An advantageous embodiment is when welding takes place using a mobile laser apparatus. Repairs can thus be carried out directly on the spot. With this the expensive and time-consuming disassembly and transport of a turbine or of a turbine rotor can be avoided for example, because defect or damaged turbine blades can be carried out directly at the place of operation of the turbine and mostly without dismantling the rotor.

A component is further proposed by the invention with a metallic substrate and a erosion protection layer applied to the substrate wherein the erosion protection layer is manufactured using a method in accordance with the invention.

Even in the component in accordance with the invention, preferably only the region of the substrate is provided with an erosion protection layer, which is most susceptible to erosion in the operating state.

In a preferred embodiment the component is designed as a turbine blade or as a compressor blade, in particular as the blade of a gas or steam turbine.

Further advantageous measures and preferable embodiments of the invention result from the dependent claims.

The invention will be explained in more detail in the following with the help of embodiments and with the help of the drawing. The schematic drawing shows, partly in section:

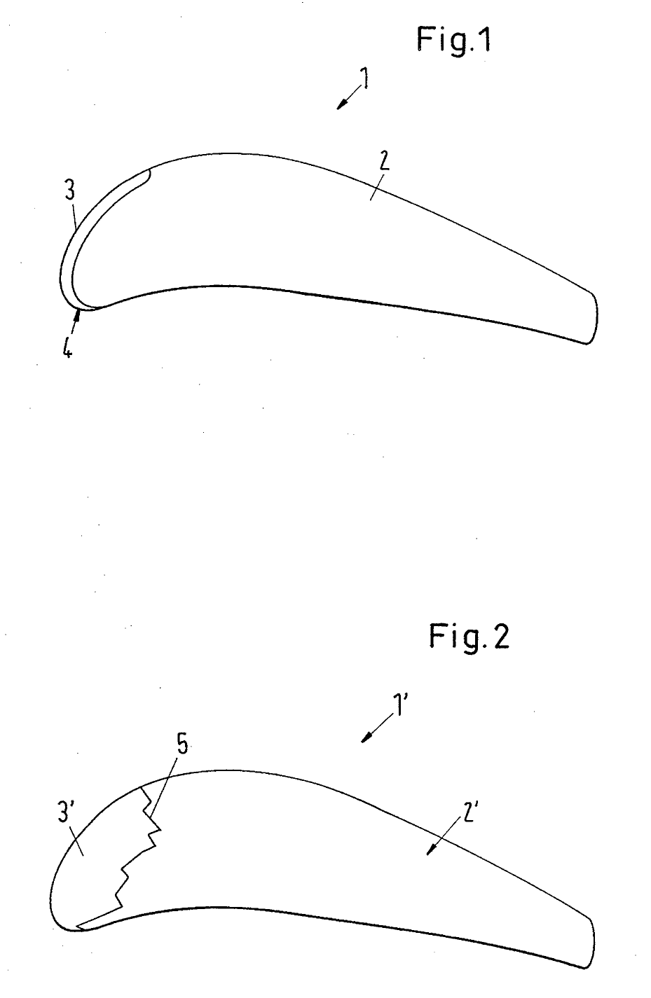

FIG. 1 a section through a turbine blade of a steam turbine, which is newly manufactured by means of an embodiment of the method in accordance with the invention,

FIG. 2 a section through a turbine blade of a steam turbine, which is repaired by means of an embodiment of the method in accordance with the invention and

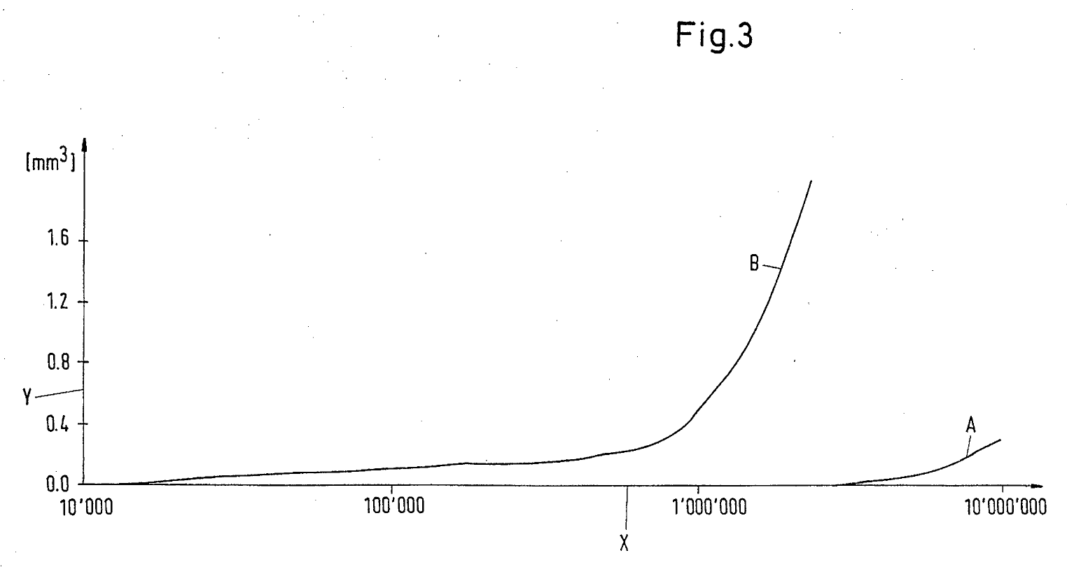

FIG. 3 a diagram to illustrate the resistance to erosion.

The method in accordance with the invention serves for the manufacture of an erosion protection layer 3 (see FIG. 1) on a metallic substrate.

The term erosion is to be understood such that it includes effects or damage caused by cavitation.

Depending on the specific application the erosion protection layer 3 can protect against different kinds of erosion, for example against droplet erosion, especially water droplet erosion, against erosion due to solid particles or suspended particles such as sand for example or also against signs of erosion which are caused by cavitation.

In principle, the method in accordance with the invention is suitable for all apparatus in which components are exposed to erosion. These are in particular flow machines, rotary engines, rotary pumps such as centrifugal or axial pumps for example, turbines in general, turbines which are operated using liquids—for example water turbines with Pelton wheels or other wheels—gas turbines, steam turbines.

Reference will be made in the following as an example to a specific example which is particularly important in practice, in which the erosion protection layer is intended to protect the turbine blades of a steam turbine against water droplet erosion. In steam turbines water droplet erosion can lead to considerable damage to the blades and in particular to the rotating turbine blades. Especially in the colder region of the turbines and/or in low pressure steam turbines it regularly happens that the temperature and pressure conditions lead to the condensing out of water droplets, which then impinge at high relative velocity on the turbine blades and cause considerable damage there by material abrasion. It is in particular the front edge or the leading edge of the turbine blade which is most exposed to erosion in operation.

In accordance with the invention a method is now proposed to manufacture an erosion protection layer 3 on a metallic substrate. FIG. 1 shows a section through a newly manufactured component, which is designed here as a turbine blade 1 of a steam turbine. The turbine blade 1 includes a metallic substrate 2 and an erosion protection layer 3 applied on the sub-strate 2. The erosion protection layer 3 is applied in the region of the blade front edge 4 in such a way that at least the entire blade front edge 4 is protected by the erosion protection layer 3.

For the manufacture the metallic substrate 2 is firstly manufactured in the form of the turbine blades in a manner known per se. In this connection a recess can be provided on the blade front edge 4, which takes up the erosion protection layer 3. This recess can either be provided directly during the manufacture of the metallic substrate 2 or can be produced after manufacture by a machining step such as milling or grinding. It is naturally also alternatively possible to apply the erosion protection layer 3 to the blade front edge 4 without a special recess being provided for it.

In the next process step, the manufacture of the erosion protection layer 3 takes place. This is applied onto the metallic layer 2 by means of laser deposition welding of a material. The technology of laser deposition welding is sufficiently known to the person skilled in the art and therefore does not have to be explained in more detail here. All laser welding apparatuses usually used for welding are suitable, in particular Nd:YAD lasers, diode lasers, fiber lasers and disc lasers with typical wavelengths between 1060 and 1070 nm and CO2 lasers with a wavelength of 10600 nm.

In accordance with the invention the material from which the erosion protection layer 3 is manufactured by means of laser deposition welding is a steel, which contains at least 0.1% carbon (C) and at least 12% chrome.

Within the scope of this application percentages are always meant as percentages by weight.

The high chrome content of the steel endows the erosion protection layer with a very good resistance to corrosion. The steel is a stainless steel in particular.

The high carbon content of the steel gives the erosion protection layer 3 a high hardness, which guarantees the resistance to erosion.

The steel is a martensitic steel in particular; this means that at least one part of the structure is martensite.

The steel is in particular a hardenable and air temperable steel, i.e. the carbon content of the steel is so high that the steel is air temperable. This means, the steel does not have to be cooled by means of oil or water after the laser deposition welding, but rather the gradient with which the steel is cooled in the air is large enough to at least partially produce a martensitic structure.

The erosion protection layer 3 preferably has an at least predominantly a martensitic structure after cooling down.

In practice it has proved particularly useful when the material is a steel, which contains at least 0.2% carbon and preferably at least 0.4% carbon. The erosion protection layer attains a particularly good hardness through this high C content. Since the technology of laser deposition welding is used for welding, the high carbon content does not present a problem for the welding process.

It has been shown, for example, that very good results can be achieved with the steel X42 Cr13. This commercially obtainable steel has a carbon content of 0.42% and a chrome content of 13%. The steel X20 Cr13 is named here as a further example, which has a carbon content of 0.2% and a chrome content of 13%.

In the manufacture of new blades 1 the thickness of the erosion protection layer usually amounts to 0.2 to 1.5 mm.

FIG. 2 shows an example, in which the repair of a component was carried out. In FIG. 2 a section through a turbine blade 1′ of a gas turbine is shown, which is repaired by means of an embodiment of the method in accordance with the invention.

During the operation of the steam turbine an extensive material removal has taken place in the region of the blade front edge due to water droplet erosion. Prior to the carrying out of the repair the blade front edge had the contour or surface illustrated by the line 5. In accordance with the invention the erosion protection layer 3′ is now generated on the remaining metallic substrate 2′ by means of laser deposition welding—if necessary after prior cleaning or preparatory steps, by welding a steel with at least 0.1% C and at least 12% Cr onto the metallic substrate 2′.

In this connection the laser welding process is controlled in such a way that the original shape of the turbine blades 1′ and in particular the original shape of the blade front edge is reconstructed. In this connection it is particularly advantageous that the material used in accordance with the invention can be a construction material, in other words a material with which not only one coating can take place, but with which the original shape of the component can be reconstructed. The steel X42 Cr 13 is also particularly suitable for this.

It is particularly advantageous to use a mobile laser apparatus for the laser deposition welding, particularly in view of repairs. Using a mobile laser apparatus the turbine blades can be repaired directly at the place of operation and, if necessary, without complete disassembly of the turbine or of the rotor. This is particularly advantageous from an economical point of view because transport times for the turbine blades to be repaired are dispensed with and, depending on the application, assembly and disassembly work can be cut down on. Thus the downtimes caused by the repair can be reduced considerably.

In the following a erosion protection layer generated in accordance with the invention will be compared with a protective layer from the prior art with the help of an example and with the help of FIG. 3. The experiments relating to erosion resistance are carried out in a water droplet erosion test bed. There a sample of the material to be tested is placed on a rotor. Water droplets, which impact cyclically on the sample attached to the rotating rotor are expelled by means of a stationary injection nozzle.

The shape and the dimensions of the sample are determined by the test bed. The samples are substantially of parallelepiped shape with 25 mm×8 mm×3 mm and are provided with a chamfer of 30°. One of the samples, the sample A, is manufactured according to a method in accordance with the invention and comprises a metallic substrate 2 on which the erosion protection layer 3 is provided. The erosion protection layer 3 comprises a steel X42 Cr 13, which was applied to the substrate 2 by laser deposition welding.

As a comparison a sample B in accordance with the prior art is used, made of a material which is often used today and is known for its good resistance to erosion. A forged strip of stellite 6 is soldered onto a metallic base body.

The two samples are tested under the following experimental conditions: the water droplets have a diameter of 0.2 mm and impact on the respective sample at a speed of 400 m/s. Up to ten million cycles are run through, i.e. in its rotation the sample passes the stationary injection nozzle up to ten million times, which means that up to ten million water droplets impact on the sample.

The mass loss of the respective sample is determined as the result for the test of water droplet erosion. From this the volume loss is then calculated with the aid of the respective specific density of the volume loss. The density for the sample A amounts to 7.70 g/cm³, the density for the sample B amounts to 8.15 g/cm³.

The result is graphically illustrated in FIG. 3. The number of the cycles, which is identical with the number of the impingements, is plotted against the horizontal axis X, which has a logarithmic scale. The volume loss is plotted against the vertical axis Y, which has a linear graduation, in mm³. The curve labeled A belongs to the sample A, which is manufactured according to a method in accordance with the invention, the one labeled B belongs to the sample B, which is manufactured in accordance with the prior art. It is clearly recognizable that the sample A has a considerably better resistance to erosion. While in the case of the sample B the volume loss after a million cycles already amounts to 0.49 mm³ and then increases rapidly, the volume loss in sample A only amounts to 0.317 mm³ even after ten million cycles.

Furthermore, an incubation period is determined which is a measure of how long it is before damage due to material removal occurs. This incubation period is defined as the number of the cycles in which a volume loss of 0.1 mm³ is reached. The incubation period for the sample A manufactured in accordance with the invention amounts to six million cycles, while the incubation period for the sample B amounts to a mere 100,000 cycles.

This result demonstrates very clearly that erosion protection layers can be manufactured using the method in accordance with the invention which protect against erosion considerably better than other methods which are known from the prior art.

Even if reference has been made here to the component of practical relevance of a turbine blade for a steam turbine, the invention is in no way limited to these components.

Water droplet erosion can also occur on the impeller side or the compressor side of a gas turbine for example. The method in accordance with the invention is also particularly suitable to generate an erosion protection layer on such compressor blades of a gas turbine, both in the manufacture of new parts and also in the repair of damaged blades in gas turbines.

The method in accordance with the invention is also suitable to protect the vanes or the blades in liquid turbines, in water turbines, for example Pelton turbines, in rotary pumps or in flow machines in general against damage due to cavitation effects.

The method in accordance with the invention is further suitable to protect the vanes or the blades in gas, steam and liquid turbines, in water turbines, for example Pelton turbines, in rotary pumps or in flow machines in general against erosion damage which can be caused by solid material particles, for example by sand or by suspended particles.

Accordingly, the components in accordance with the invention can also be formed in particular as turbine blades in all types of turbine, as blades of rotors, as rotors in general or as other components in rotary machines and flow machines exposed to erosion.

In turbines the method in accordance with the invention is suitable both for the blades or vanes of rotating engine parts (rotors) and for the blades of the stationary components, such as the guide vanes for example.

1. A method for the manufacture of an erosion protection layer on a metallic substrate in which a material is welded onto the metallic substrate (2, 2′), characterized in that the material is a steel which contains at least 0.1% carbon and at least 12% chrome and that the material is applied to the substrate (2, 2′) by laser deposition welding.

2. A method in accordance with claim 1, in which the material contains at least 0.2% carbon and preferably at least 0.4% carbon.

3. A method in accordance with claim 1 with which the repair of a component (1) is carried out.

4. A method in accordance with claim 1 with which the new manufacture of a component (1) is carried out.

5. A method in accordance with claim 3, in which the component (1, 1′) is a compressor blade or a turbine blade.

6. A method in accordance with claim 1, wherein only the region of the substrate (2), which is most liable to erosion in the operating state, is provided with an erosion protection layer.

7. A method in accordance with claim 1 in which the welding takes place with a mobile laser apparatus.

8. A component with a metallic substrate (2, 2′) and an erosion protection layer (3, 3′) applied to the substrate (2, 2′), characterized in that the erosion protection layer (3, 3′) is manufactured using a method in accordance with claim 1.

9. A component in accordance with claim 8 wherein only the region of the substrate (2, 2′) is provided with an erosion protection layer (3, 3′) which is most liable to erosion in the operating state.

10. A component in accordance with claim 8, designed as a turbine blade or a compressor blade, in particular as a blade of a gas or steam turbine.
